(19) United States
(12) Patent Application Publication
(10) Pub. No.: US 2015/0115509 A1
(43) Pub. Date: Apr. 30, 2015

(54) CONTACTLESS POSITION MEASUREMENT OF A MOVABLE LANCE IN CONVERTER STEEL PRODUCTION

(71) Applicant: SIEMENS VAI METALS TECHNOLOGIES GMBH, Linz (AT)

(72) Inventors: Franz Hartl, Linz (AT); Thomas Kurzmann, Marchtrenk (AT)

(21) Appl. No.: 14/398,364

(22) PCT Filed: Apr. 22, 2013
(86) PCT No.: PCT/EP2013/058259

§ 371 Date: Oct. 31, 2014

(30) Foreign Application Priority Data
May 4, 2012 (AT) A531/2012

(51) Int. Cl. G01B 7/00; C21C 7/068

(52) U.S. Cl. CPC G01B 7/00; C21C 7/068
USPC 266/99; 702/150

(57) ABSTRACT

A system including a movable lance (1), which measures or influences physical or chemical quantities of a melt (2) in a converter (3), and a device for contactless position measurement of the movable lance (1). Also, a converter system including such a system and a method for the contactless position measurement of the movable lance (1). For position measurement of a movable lance (1) in converter steel production, the system has a stationary transmitter (4) for emitting electromagnetic waves (7), a stationary receiver (5) for receiving the emitted electromagnetic waves (7), a reflector (6), which is connected to the movable lance (1) and on which the electromagnetic waves (7) can be reflected, and a calculator (8) for calculating the absolute position of the lance from the propagation time of the electromagnetic waves (7) emitted by the transmitter (4) in the direction of the reflector (6), reflected by the reflector (6) in the direction (2) of the receiver means (5), and received by the receiver (5).

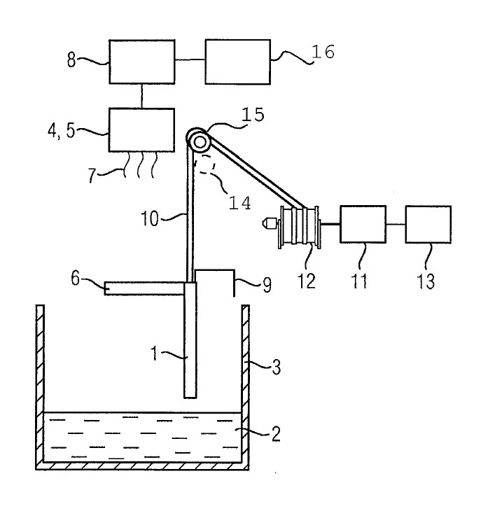

### CROSS-REFERENCE TO RELATED APPLICATIONS

The present application is a 35 U.S.C. §§371 National Phase conversion of PCT/EP2013/058259, filed Apr. 22, 2013, which claims priority of Austrian Patent Application No. A531/2012, filed May 4, 2012, the contents of which are incorporated by reference herein. The PCT International Application was published in the German language.

### TECHNICAL FIELD

The invention relates to a system comprising a movable lance, which is intended for measuring or influencing physical or chemical quantities of a melt in a converter, and an apparatus which for contactless position measurement of the movable lance.

The invention further relates to a converter system with such a system and to a method for contactless position measurement of the movable lance.

### TECHNICAL BACKGROUND

Such a system and the converter system, and such a method are used in converter steel production, for example. A converter in the context of steel manufacture involves a container in which surplus carbon is oxidized out by feeding oxygen into liquefied pig iron, for example.

Different mobile lance systems, such as oxygen blowing lances or lance devices for taking samples or for determining steel bath temperature, carbon content or oxygen activity are used in converter steel production, wherein the latter lance devices are called sublance devices.

In particular when water-cooled lances are involved, the safe position determination of the lance is of great importance, since a collision between the water-cooled lance and the converter vessel can cause cooling water to escape from the lance. If a dangerous amount of water has escaped, this can lead in the converter to explosive evaporation (spontaneous evaporation), dissociation (water splitting) and also oxidation effects (chemical binding of the oxygen atoms). The potential danger arising as a result is not to be ignored.

Previously the position of the movable lance has been measured as follows. The lance hangs on one end of a cable which is wound at its other end onto a cable drum. A drive motor is connected to the cable drum, so that the drive motor, in accordance with the specification of a linked controller, can move the lance vertically by means of the cable. The position is measured in this case by means of an absolute value encoder attached to the rotating part of the cable drum, wherein the exact lance position is only accessible from a corresponding computation by the controller. Thus the measurement provided is indirect and also contact-based.

### SUMMARY OF THE INVENTION

The underlying object of the invention is to make possible a position measurement of a movable lance for converter steel production, which is as simple as possible and at the same time is as safe as possible.

This object is achieved by a system of the type described above in that the system has stationary transmitting means or a transmitter for transmitting electromagnetic waves, stationary receiving means or a receiver for receiving the transmitted electromagnetic waves, a reflector which is at or connected to the movable lance and on which the electromagnetic waves are able to be reflected and computation means or a computation device for computing the absolute position of the lance from the propagation time of the electromagnetic waves transmitted by the transmitting means in the direction of the reflector, reflected by the reflector in the direction of the receiving means and received by the receiving means.

This object is further achieved by a converter system of the type described above, by the converter system having a converter, a cable on which the lance is suspended, and a drive unit by means of which the cable and the lance can be moved.

Finally this object is achieved by a method of the type described above by the following method steps:
Transmitting of electromagnetic waves by means of stationary transmitting means,
Receiving of the transmitted electromagnetic waves by means of stationary receiving means,
Computation of the absolute position of the lance by means of computation means from the propagation time of the electromagnetic waves transmitted in the direction of a reflector connected to the movable lance and reflection of the electromagnetic waves reflected by the reflector in the direction of the receiving means and received by the receiving means.

The inventive system bus allows both discrete and also continuous lance position detection with high precision. In this case the position measurement is insensitive to dust, smoke and flames and can be carried out independently of temperature, air pressure and air humidity, wherein in a steelworks environment the dust can especially contain graphite, be electrically-conducting and be light-reflecting. In the steel production environment in particular, the properties of the invention thus offer great advantages.

Devices previously used for detecting lance positions, with an absolute value generator attached to the cable drum, which only makes indirect lance position detection possible, the inventive system has the advantage of direct position measurement of the lance. The particularly advantageous aspect of direct lance position detection is that it avoids often imprecise additional information which is needed for indirect measurement by means of the absolute value generator can only be provided with extra effort or in a roundabout way. This previously required additional information includes, for example how many layers of the cable are already wound onto the drum as well as the thickness of the cable, as well as mechanical properties of the cable. The latter properties include the extension of the cable as a function of the mechanical tension of the cable, which in its turn depends on the mass of the lance.

In accordance with the invention, the lance is suspended from a cable, wherein the cable and the lance can be moved by means of a drive unit. It is possible for the drive unit to drive a cable drum on which the cable is wound. The cable can then move the lance in a vertical direction via a deflection roller. As an alternative, the drive unit may be connected to a drive pulley, with which the lance can be moved in the vertical direction, if necessary also via a deflection roller.

Furthermore, compared to systems for lance position detection currently in use, a plurality of limit switches along the lance guidance can be dispensed with. The limit switches, for example in the form of contact switches or inductive proximity switches, have previously been used to detect whether the lance has reached a specific position and are therefore attached in relatively greater numbers along the lance guidance. For inventive contactless position determination of the lance, the number of limit switches can be fewer than has been needed.

The inventive system is especially advantageous because the direct position measurement of the movable lance avoids need for the above-mentioned information for previous position measurement, which is often difficult to procure and is always prone to errors and tolerances, and a plurality of limit switches can be omitted. It is also of advantage that the measurement is carried out in a contactless manner, because, for example, no wear should occur.

In an advantageous embodiment of the invention the electromagnetic waves are microwaves. The use of microwaves allows an especially reliable position measurement in the steel production environment, since the waves are especially insensitive to adverse conditions resulting from contamination and dust, as well as vibrations. Vibrations in particular are inevitable during steel production, so that a reliable position measurement of the lance, even when vibrations are occurring, is especially advantageous.

In a further advantageous embodiment of the invention, the lance is water-cooled. Such lances are used for example as oxygen blower lances or as lance devices for taking samples or for determining the steel bath temperature, the carbon content or the oxygen activity. The collision of water-cooled lances with the converter represents an especially great potential danger, so that reliable position measurement is especially important for such lances.

In a further advantageous embodiment of the invention, the transmitting means, the receiving means and the computation means fulfill at least the International standard of safety integrity level 2 (SIL2) defined as a relative level of risk reduction provided by a safety function. In conjunction with functional safety the safety integrity level is also known in international standardization as IEC 61508/IEC61511 (see below). The level of safety serves to assess electrical, electronic or programmable electronic systems in relation to the reliability of safety functions. The safety-related construction principles which should be adhered to are produced from the intended level, so that the risk of a malfunction can be minimized. When at least SIL2 is to be fulfilled, this is to be understood as the requirements of SIL2 or of higher-level technical safety requirements having to be fulfilled.

Thanks to the use of transmitting means, receiving means and computation means which fulfill at least SIL2, the position of the lance is measured at least in accordance with SIL2. This can be confirmed by means of a risk analysis required by the International functional safety requirements and the International safety international system standards in the process sector IEC61508/IEC61511. To comply with IEC 61508/IEC61511, cyclic checking of the apparatus for contactless position measurement is additionally necessary, wherein the checking can also be carried out manually, since the cycle time to be adhered to amounts to one year. The absolute lance position, for example of an oxygen blower lance or of sublances, is thus detected by means of a safety-certified position measuring system. This means that safety standards are fulfilled which make the entire steel production plant more reliable and, in the event of a fault, lead to shorter operational outages and fewer serious accidents.

Furthermore the drive unit, the controller and possibly communication buses can be designed such that they fulfill at least SIL2. Further parts of the converter system can also be designed in accordance with at least SIL2, such as the cable or drum via which the cable is diverted for example or on which the cable is wound. Thus a converter system is obtained which overall also corresponds to the technological safety requirements of at least SIL2. Thus the system, as well as the converter system, are also suitable for the converter tipping drive for tilting the converter vessel and the movable lance can be locked with the converter movement for safety reasons.

In a further advantageous embodiment of the invention a hypothetical reference point is provided, wherein by means of a measuring device fulfilling at least safety integrity level 2 (SIL2), a calibration of the computed absolute position of the lance is able to be undertaken on the basis of the reference point. The measuring device is connected to the computation means so that the position of the lance measured by the measuring device can be transmitted to the computation means. The reference point is advantageously located along the movement path of the lance, for example at the upper end of the lance guidance, and is stationary in relation to the converter vessel and the lance, so that it represents a fixed reference point for the transmitting means and the receiving means.

Through the measuring device which fulfils the requirements of at least SIL2, thanks to the reference point, a calibration or referencing of the position signal can take place, which likewise fulfills the requirements of at least SIL2. Through the calibration or referencing of the position signal, a cyclic check of the apparatus for contactless position measurement is possible. In this case, it is of advantage for the cycle time to be able to be kept very short, so that an automated referencing carried out several times per day or several times per hour is made possible. This means that manual measuring of the lance, in which the measured position would have to be manually supplied to the computation means, is no longer needed.

Thus, the position of the movable lance is determined over two channels, through which the category 3 in accordance with standard EN ISO 13849-1 is additionally fulfilled. ISO 13849 is an International safety standard which deals with safety related design principles of employed control systems. In relation to the position determination, this means that an individual error does not lead to the failure of the safety functions and that, if an error is present, the error will be detected before the safety functions are next required. By fulfilling the two above-mentioned standards, it is thus made possible to reach an especially high safety standard.

The measuring device can especially be embodied as a sensor or limit switch, for example in the form of a contact switch or an inductive proximity switch.

### BRIEF DESCRIPTION OF THE DRAWING

The invention is described and explained in greater detail below on the basis of the exemplary embodiment shown in the FIGURE which shows an exemplary embodiment of an inventive system and of an inventive converter system.

### DESCRIPTION OF AN EMBODIMENT

In an exemplary embodiment of an inventive system and an inventive converter system, a melt 2 is located in a converter 3. Physical or chemical properties of the melt 2 can be measured and/or influenced by a lance 1 projecting into the converter 3. The lance 1, of this exemplary embodiment has a cooling water supply 9 so that the lance is water-cooled.

Attached at or to the lance 1 is a reflector 6 in the form of a metallic plate which can reflect electromagnetic waves 7 which are transmitted by transmitting means 4 or a transmitter in the direction of the reflector 6. The reflected electromagnetic waves 7 can be received by receiving means 5 or a receiver. Both the transmitting means 4 and the receiving means 5 are connected to computation means 8 or a computation device which can compute the absolute position of the lance 1 from the propagation time of the electromagnetic waves 7 transmitted in the direction of the reflector 6, reflected by the reflector 6 in the direction of the receiving means 5 and received by the receiving means 5.

The lance 1 hangs on two cables 10, which are connected for example via a deflection roller to a cable drum 12 and are wound onto the drum. The cable drum 12 and thus the cable 10 and also the lance 1 can be moved by means of a drive unit 11, which for its part is connected to a controller 13. A drive pulley can also be used as an alternative for the cable drum 12 for example.

A hypothetical reference point 14 as well as an additional measurement device 16 by means of which a calibration of the computed absolute position of the lance 1 is able to be undertaken. Within the context of the exemplary embodiment the reference point 14 is located within the movement interval of the movable lance 1 at the upper end of the lance guidance, in the immediate vicinity of the diversion drum 15. The measurement device 16 is connected to the computation means 8, so that the measured position of the lance can be transmitted to the computation means 8. A manual measurement of the lance 1 would have to be entered manually.

In summary the invention relates to a system comprising a movable lance which is intended for measuring or influencing physical or chemical quantities of a melt in a converter, and an apparatus which is intended for contactless position measurement of the movable lance. The invention further relates to a converter system with such a system and to a method for contactless position measurement of the movable lance. To make possible a position measurement of a movable lance during steel production that is as simple as possible and at the same time is as safe as possible, it is proposed that the system has stationary transmitting means for transmitting electromagnetic waves, stationary receiving means for receiving the transmitted electromagnetic waves, a reflector which is connected to the movable lance and at which the electromagnetic waves are able to be reflected, and computation means for computing the absolute position of the lance from the propagation time of the electromagnetic waves transmitted in the direction of the reflector, reflected by the reflector in the direction of the receiving means and received by the receiving means.

1. A system comprising:
a movable lance which is configured for measuring or influencing physical or chemical quantities of a melt in a converter;
an apparatus configured for contactless position measurement of the movable lance comprising:
a stationary transmitter configured for transmitting electromagnetic waves;
a stationary receiver for receiving the transmitted electromagnetic waves;
a reflector connected to the movable lance located and configured so that the electromagnetic waves from the transmitter are reflected to the receiver; and
a computation device configured for computing the absolute position of the lance based on the propagation time of the electromagnetic waves transmitted by the transmitter toward the reflector, reflected by the reflector toward the receiver and received by the receiver.

2. The system as claimed in claim 1, wherein the electromagnetic waves are microwaves.

3. The system as claimed in claim 1, wherein the lance is water-cooled.

4. The system as claimed in claim 1, wherein the transmitter, the receiver and the computation device fulfill at least safety integrity level 2 (SIL2).

5. The system as claimed in claim 1, wherein a reference point is provided, a measurement device fulfilling at least safety integrity level 2 (SIL2) is configured for calibrating the computed absolute position on the basis of the reference point.

6. A converter system comprising:
a system as claimed in claim 1;
a converter for use in steel production and configured for containing melt for the steel production;
a cable from which the lance is suspended in the container; and
a drive unit configured for moving the cable and the lance.

7. A method for contactless position measurement of a movable lance, wherein the lance is configured for measuring or influencing physical or chemical variables of a melt in a converter, containing melt for steel production;
the method steps comprising:
transmitting electromagnetic waves by a stationary transmitter;
receiving the transmitted electromagnetic waves by a stationary receiver;
positioning an electromagnetic wave reflector at the movable lance, the reflector configured for receiving the waves from the transmitter and reflecting the waves to the receiver; and
computing the absolute position of the lance from the propagation time of the electromagnetic waves transmitted in a direction of the reflector which is positioned at the movable lance and reflecting the electromagnetic waves in the direction of the receiver to be received by the receiver.

8. The method as claimed in claim 7, further comprising calibrating the computed absolute position of the lance based on a reference point by means of a measurement device fulfilling at least safety integrity level 2 (SIL2).
